(19) United States
(12) Patent Application Publication
(10) Pub. No.: US 2019/0044297 A1
(43) Pub. Date: Feb. 7, 2019

(54) WIRE BONDING STRUCTURE AND WIRE BONDING METHOD

(71) Applicant: Yazaki Corporation, Tokyo (JP)

(72) Inventors: Yasunori NABETA, Shizuoka (JP); Kazuhide TAKAHASHI, Shizuoka (JP)

(73) Assignee: Yazaki Corporation, Tokyo (JP)

(21) Appl. No.: 16/047,217

(22) Filed: Jul. 27, 2018

(30) Foreign Application Priority Data
Aug. 2, 2017 (JP) 2017-149836

(51) Int. Cl. H01R 43/02; B23K 20/10

(52) U.S. Cl. CPC H01R 43/0263; B23K 20/10; H01R 43/0207

(57) ABSTRACT

A wire bonding structure includes a wire support and a plurality of wires. The wire support is made of a water-impermeable material and is provided with a plurality of through-holes, and an inner diameter of some through-holes among the plurality of through-holes is different from an inner diameter of the other through-holes among the plurality of through-holes. Each of the plurality of wires is configured to include a conductor and a sheath covering the conductor, the sheath is removed at a part in a longitudinal direction to expose the conductor, the conductors penetrate through at least some through-holes among the plurality of through-holes of the wire support such that the exposed conductors are positioned on one side of the wire support, and the conductors penetrated through the through-holes are bonded to each other.

### CROSS REFERENCE TO RELATED APPLICATION

This application is based upon and claims the benefit of priority from the prior Japanese Patent Application No. 2017-149836 (filing date: Aug. 2, 2017), the entire contents of which are incorporated herein by reference.

### BACKGROUND

### Technical Field

The present invention relates to a wire bonding structure and a wire bonding method, and particularly to a wire support having a plurality of wires penetrating therethrough.

### Related Art

Conventionally, a wire bonding structure in which exposed conductors of a plurality of wires are bonded to each other, for example, by ultrasonic bonding is known (see JP 2013-17286 A).

### SUMMARY

Meanwhile, it is important to define the arrangement of conductors when bonding the conductors of the wires to each other. That is, if the arrangement of conductors is made unsuitable for bonding, there is a problem that bonding failure occurs between the conductors. This bonding failure naturally occurs even when the conductors to be bonded have different diameters.

The invention has been made in view of the above problem, and an object thereof is to provide a wire bonding structure and a wire bonding method capable of defining the arrangement of conductors when bonding the conductors of wires having different diameters to each other and eliminating bonding failure between the conductors by precisely bonding the conductors to each other.

A wire bonding structure according to a first aspect of the invention includes a wire support and a plurality of wires. The wire support is made of a water-impermeable material and is provided with a plurality of through-holes, and an inner diameter of some through-holes among the plurality of through-holes is different from an inner diameter of the other through-holes among the plurality of through-holes. Each of the plurality of wires is configured to include a conductor and a sheath covering the conductor, the sheath is removed at a part in a longitudinal direction to expose the conductor, the conductors penetrate through at least some through-holes among the plurality of through-holes of the wire support such that the exposed conductors are positioned on one side of the wire support, and the conductors penetrated through the through-holes are bonded to each other.

This wire bonding structure may have a dummy plug that closes the remaining through-hole of the plurality of through-holes of the wire support.

The wire bonding structure may have a sealing member that covers a part of the wire support and the conductors exposed to the one side of the wire support.

The sealing member may be configured to be installed on the wire support, and an installation state holding portion configured to prevent the sealing member installed on the wire support from being disengaged from the wire support may be provided.

A wire bonding method according to a second aspect of the invention is a method for bonding a plurality of wires penetrating through a wire support. Each wire includes a conductor and a sheath covering the conductor. The wire support is made of a water-impermeable material and is provided with a plurality of through-holes such that an inner diameter of some through-holes among the plurality of through-holes is different from an inner diameter of the other through-holes among the plurality of through-holes. The wire bonding method includes: installing each wire of the plurality of wires into each through-hole, which is at least some of through-holes among the plurality of through-holes, so as the plurality of wires to penetrate through the at least some of through-holes to protrude toward one side of the wire support by a predetermined length; removing the sheath at a part in a longitudinal direction of each of the wires protruding toward the one side of the wire support by the predetermined length; installing a dummy plug to a remaining through-hole of the plurality of through-holes of the wire support to close the remaining through-hole; bonding the conductors positioned on the one side of the wire support to each other; and sealing a part of the wire support and the conductors exposed to the one side of the wire support by installing a sealing member on the wire support after bonding the conductors to each other.

The aspects according to the invention define the arrangement of the conductors when bonding the conductors of the wires having different diameters to each other and to eliminate the bonding failure between the conductors by accurately bonding the conductors to each other.

### BRIEF DESCRIPTION OF DRAWINGS

FIG. 1A is a view illustrating a wire support used in a wire bonding structure according to an embodiment of the invention;

FIG. 1B is a view taken along an arrow IB in FIG. 1A;

FIG. 2A is a view illustrating a process of manufacturing the wire bonding structure according to the embodiment of the invention;

FIG. 2B is a view illustrating a cross section taken along a line IIB-IIB in FIG. 2A;

FIG. 3 is a view illustrating the wire bonding structure according to the embodiment of the invention;

FIG. 4 is a view illustrating the wire bonding structure according to the embodiment of the invention in which a sealing member is installed;

FIG. 5A is a view illustrating ultrasonic bonding according to a comparative example;

FIG. 5B is a view illustrating a cross section taken along a line VB-VB in FIG. 5A;

FIG. 6A is a view schematically illustrating ultrasonic bonding in the wire bonding structure according to the embodiment of the invention;

FIG. 6B is a view illustrating a cross section taken along a line VIB-VIB in FIG. 6A;

FIG. 7A is a view illustrating a process of manufacturing the wire bonding structure according to the embodiment of the invention, the view illustrating the structure in which a dummy plug is used;

FIG. 7B is a view illustrating a cross section taken along a line VIIB-VIIB in FIG. 7A;

FIG. 8 is a perspective view of the dummy plug used in the wire bonding structure according to the embodiment of the invention; and

FIG. 9 is a view illustrating the wire bonding structure according to the embodiment of the invention, the view illustrating the structure in which an installation state holding portion is provided.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

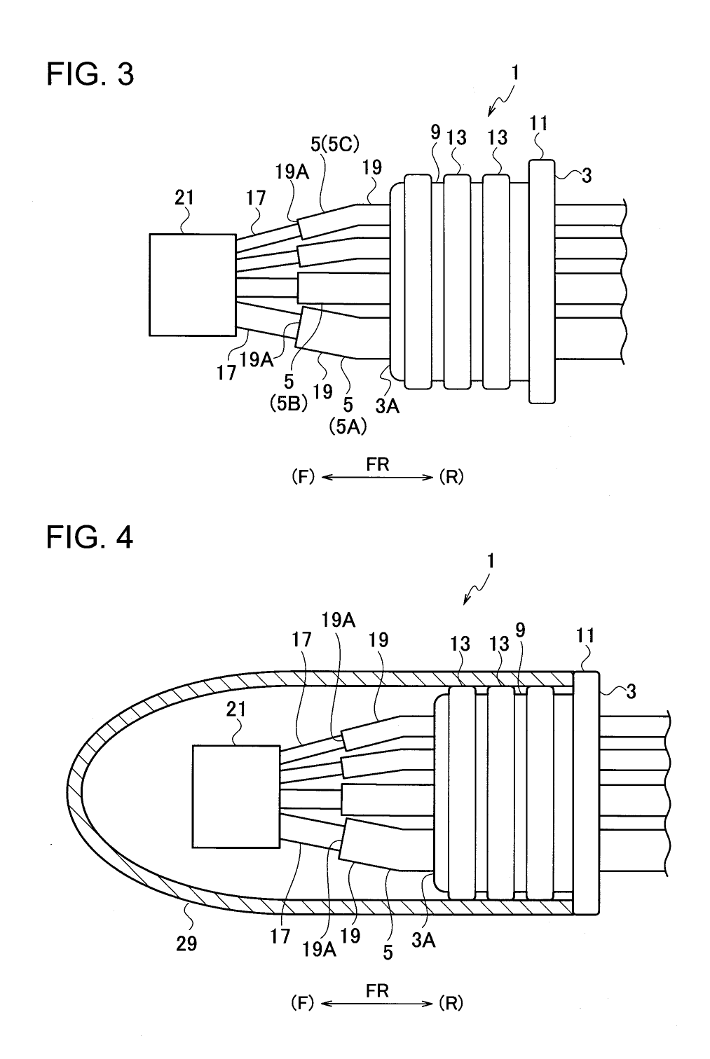

A wire bonding structure 1 according to an embodiment of the invention is configured to include a wire support 3 and a plurality of (at least two) wires 5 as illustrated in FIGS. 3, 4, and the like. For example, the wire support 3 is a rubber plug. Here, it is assumed that a longitudinal direction of the wire 5 is a front-rear direction FR for convenience of description.

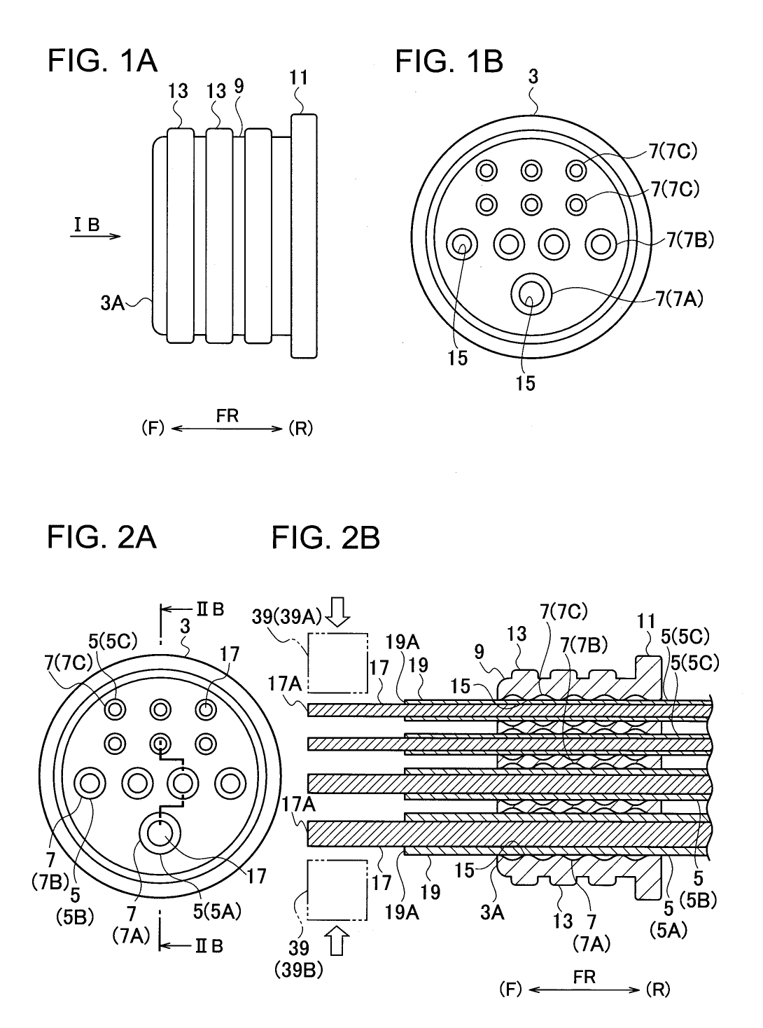

The wire support 3 is made of a water-impermeable material. In addition, the wire support 3 is provided with a plurality of through-holes 7 (see FIG. 1B and the like), and an inner diameter of some through-holes among the through-holes 7 is different from an inner diameter of the other through-holes among the through-holes.

In addition, the wire support 3 is made of a material, for example, rubber that has insulation properties and is elastically deformed, and is configured to include a cylindrical wire support main body 9, a disk-shaped flange 11 as illustrated in FIGS. 1A, 1B, and the like. An outer diameter of a circle of the disk-shaped flange 11 is larger than an outer diameter of a circle of the cylindrical wire support main body 9. The flange 11 is provided integrally with the wire support main body 9 at a rear end of the cylindrical wire support main body 9, and a center axis of the cylindrical wire support main body 9 and a center axis of the disk-shaped flange 11 coincide with each other and extend in the front-rear direction FR.

The through-hole 7 is formed in, for example, a cylindrical shape. A center axis of the cylinder of the wire support 3 and a center axis of the cylinder of the through-hole 7 are parallel to each other. The respective through-holes 7 penetrate through the wire support 3.

As viewed in an extension direction of the center axis which is a height direction of the cylinder of the wire support 3 or the through-hole 7, the plurality of circular through-holes 7 are present at the inner side of the circular wire support main body 9 to be spaced apart from each other at predetermined intervals.

Since the inner diameter of some through-holes among the through-holes 7 is different from the inner diameter of the other through-holes among the through-holes, the through-holes having various inner diameters (through-holes with at least two types of inner diameters) are provided in the wire support 3. In this case, a plurality of through-holes having the same inner diameter may be present, or inner diameters of all the through-holes may be different from each other.

Incidentally, there are one through-hole 7A having a large diameter, four through-holes 7B having a medium diameter, and six through-holes 7C having a small diameter in the wire support 3 illustrated in FIG. 1B, and the respective through-holes 7 are aligned in descending order of these inner diameters (or in ascending order).

A lip 13, which is an annular convex portion, is provided on a side surface of the cylindrical wire support main body 9. An outer diameter of a portion where the lip 13 is provided is larger than an outer diameter of a portion where the lip 13 is not provided. A plurality of the lips 13 on the side surface of the wire support main body 9 are provided and are aligned to be spaced apart from each other in the height direction of the cylindrical wire support main body 9.

In addition, a lip 15 which is an annular convex portion is also provided on an inner surface of the through-hole 7. An inner diameter of a portion where the lip 15 is provided is smaller than an inner diameter of a portion where the lip 15 is not provided. A plurality of the lips 15 on the inner surface of the through-hole 7 are also provided, and are aligned to be spaced apart from each other in the height direction of the cylindrical through-hole 7.

The wire 5 is configured to include a conductor (core wire) 17 and an insulating sheath 19 covering the conductor 17 (see FIG. 2B and the like), and the sheath 19 is removed at a part in the longitudinal direction, for example, at one end over a predetermined length to expose the conductor 17.

The wire 5 penetrates through at least some through-holes (at least two through-holes) among the through-holes 7 of the wire support 3 so that the exposed conductor 17 is positioned on one side (front side F) of the wire support 3. In FIGS. 2A and 2B, the wires 5 as many as the through-holes 7 penetrate through all of the through-holes 7, respectively. The conductors 17 of the respective wires 5 penetrating through the through-holes 7 are bonded to each other as illustrated in FIG. 3.

The wire 5 has flexibility. In addition, a cross section of the wire 5 along a plane orthogonal to the longitudinal direction is formed in a predetermined shape such as a circular shape.

More specifically, the conductor 17 is constituted by, for example, a plurality of strands (not illustrated). The strand is formed in an elongated cylindrical shape using metal such as copper, aluminum, and an aluminum alloy.

The conductor 17 is configured in a form in which the plurality of strands are twisted or a form in which the plurality of strands collectively extend in a straight line. The cross section of the conductor 17 is formed in a substantially circular shape as the plurality of strands are bundled with almost no gap.

The sheath 19 is made of, for example, thermoplastic resin, and the cross section of the sheath 19 is formed in an annular shape having a predetermined width (thickness). The entire inner circumference of the sheath 19 is in contact with the entire outer circumference of the conductor 17. Incidentally, there is also a case where the conductor 17 is constituted by a single strand.

In a state before the wire 5 penetrates through the through-hole 7, an outer diameter of the wire 5 (sheath 19) is slightly larger than an inner diameter of the lip 15 of the through-hole 7 and is slightly smaller than the inner diameter of the portion of the through-hole 7 where the lip 15 is not provided. Incidentally, an outer diameter of the conductor 17 of the wire 5 is smaller than the inner diameter of the lip 15 of the through-hole 7.

In a state where the wire 5 penetrates through the through-hole 7 (wire penetration state), the wire 5 having an outer diameter matching the inner diameter of the through-hole 7 provided in the wire support 3 penetrates through the through-hole 7 of the wire support 3 as illustrated in FIGS. 2A and 2B. That is, a wire 5A having a large outer diameter penetrates through the through-hole 7A having a large inner diameter, a wire 5B having a medium outer diameter penetrates through the through-hole 7B having a medium inner diameter, and a wire 5C having a small outer diameter penetrates through the through-hole 7C having a small inner diameter.

In the wire penetration state, each of the conductors 17 of the wires 5 penetrating through each of the through-holes 7, is positioned on one side of the wire support 3.

For example, a front end 19A of the sheath 19 of the wire 5 positioned at a rear end of the exposed conductor 17 is positioned at the front side of a front end 3A of the wire support 3 by a predetermined length in the front-rear direction FR, and the exposed conductor 17 extends by a predetermined length further forward from the front end 19A of the sheath 19 of the wire 5.

In the wire penetration state, positions of the front ends 19A of the sheaths 19 of the wires 5 coincide with each other in the front-rear direction FR regardless of the outer diameters of the wires 5, and positions of the front ends 17A of the exposed conductors 17 coincide with each other.

In addition, an outer diameter of a portion of the wire 5 in contact with the lip 15 on the inner surface of the through-hole 7 and the inner diameter of the lip 15 are equal to each other in the wire penetration state. This is achieved mainly by elastic deformation of the lip 15 of the through-hole 7.

As a result, in the wire penetration state, the annular lip 15 on an inner wall of the through-hole 7 is in close contact with the entire outer circumference of the wire 5 (sheath 19), and a gap between the wire 5 and the through-hole 7 is sealed.

The conductors 17 of the wires 5 are bonded to each other, for example, by ultrasonic bonding, and a splice 21, which is a portion where the conductors 17 are integrated with each other and is formed by ultrasonic bonding, is provided at front ends of the respective exposed conductors 17 as illustrated in FIG. 3.

Although the conductors 17 are exposed in all the wires 5 penetrating through the through-holes 7 of the wire support 3 and all the exposed conductors 17 are subjected to bonding in the above description, an aspect in which some of the wires 5 penetrating through the through-holes 7 of the wire support 3 are not subjected to bonding may be provided.

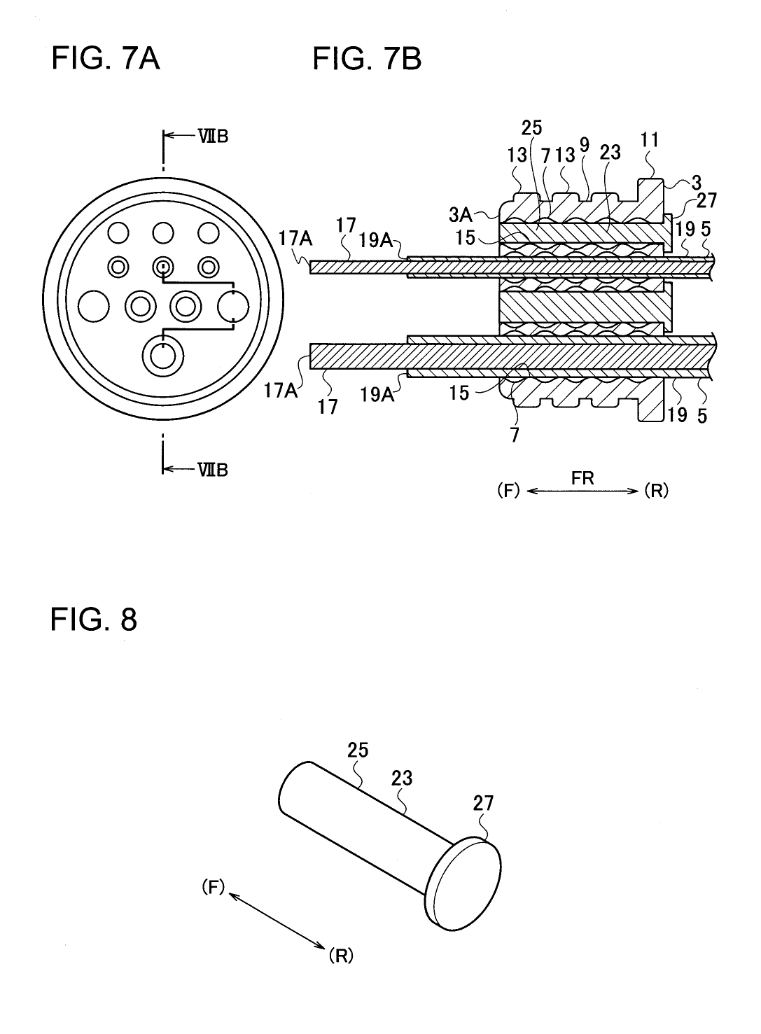

In addition, when the wires 5 do not penetrate through all the through-holes 7 of the wire support 3 in the wire bonding structure 1, a dummy plug 23 illustrated in FIG. 8 is inserted into the remaining through-holes 7 of the wire support 3 to close all the remaining through-holes 7 (see FIGS. 7A and 7B).

For example, the dummy plug 23 is made of a material having a higher elastic modulus than the wire support 3 and the sheath 19 of the wire 5, that is, the material that hardly deforms due to a force and having insulation properties such as synthetic resin.

The dummy plug 23 is configured separately from the wire support 3 and the wire 5, and is configured to include a cylindrical dummy plug main body 25 and a disk-shaped flange 27. An outer diameter of a circle of the disk-shaped flange 27 is larger than an outer diameter of a circle of the cylindrical dummy plug main body 25. The flange 27 is provided integrally with the dummy plug main body 25 at one end (rear end) of the cylindrical dummy plug main body 25, and a center axis of the cylindrical dummy plug main body 25 and a center axis of the disk-shaped flange 27 coincide with each other.

In a state before the dummy plug 23 is inserted into the through-hole 7 of the wire support 3, an outer diameter of the dummy plug main body 25 is slightly larger than the inner diameter of the lip 15 of the through-hole 7 and is slightly smaller than the inner diameter of the portion of the through-hole 7 where the lip 15 is not provided. Incidentally, an outer diameter of the flange 27 of the dummy plug 23 is larger than the inner diameter of the portion of the through-hole 7 where the lip 15 is not provided.

In addition, the dummy plug 23 having the outer diameter matching the inner diameter of the through-hole 7 provided in the wire support 3 is inserted and installed in the through-hole 7 of the wire support 3.

A dimension (a height of the cylinder) of the dummy plug main body 25 is substantially equal to a dimension (a height of the cylinder) of the through-hole 7.

In a dummy plug installation state where the dummy plug 23 is inserted and installed in the through-hole 7 of the wire support 3, the flange 27 abuts on a rear end of the wire support 3, and the dummy plug main body 25 is placed inside the through-hole 7 of the wire support 3.

In addition, an outer diameter of a portion of the dummy plug main body 25 in contact with the lip 15 on the inner surface of the through-hole 7 and the inner diameter of the lip 15 of the through-hole 7 are equal to each other in the dummy plug installation state. This is achieved mainly by elastic deformation of the lip 15 of the through-hole 7.

As a result, even in the dummy plug installation state, the annular lip 15 on the inner wall of the through-hole 7 is in close contact with the entire outer circumference of the dummy plug main body 25, and a gap between the dummy plug main body 25 and the through-hole 7 is sealed.

When the dummy plug 23 is installed in the remaining through-hole 7 after the installation by inserting the wires 5 into the some through-holes 7 among the through-holes 7 of the wire support 3 is completed, the wire support 3 is slightly elastically deformed. As a result, the lip 15 of the through-hole 7 is brought into close contact with the entire outer circumference of the sheath 19 of the wire 5 with a larger biasing force than the state before installing the dummy plug 23.

When a plurality of the through-holes 7 into which the dummy plugs 23 are inserted are present in the wire support 3, a plurality of the dummy plugs 23 are also prepared, but these dummy plugs 23 are separate from each other.

In addition, a dummy wire (not illustrated) whose conductor is not bonded to another conductor may be inserted and installed in the through-hole 7 instead of the dummy plug 23. In this case, each portion among a number of strands constituting the conductor of the dummy wire is filled with a sealing material so that water or the like does not pass through the portion among the strands of the dummy wire.

In addition, a sealing member (waterproof cap) 29 is provided in the wire bonding structure 1 as illustrated in FIG. 4. The waterproof cap 29 is configured to be installed on the wire support 3 and covers a part of the wire support 3 and the conductor 17 exposed to the one side (front side F) of the wire support 3 including the splice 21.

For example, the waterproof cap 29 is formed in a bottomed tubular shape using a material such as synthetic resin having higher rigidity than the wire support 3 and having insulation properties.

In a state before the waterproof cap 29 is installed on the wire support 3, an inner diameter of a portion of the waterproof cap 29 to be engaged with the wire support main body 9 is slightly smaller than the outer diameter of the lip 13 of the wire support 3, and is slightly larger than the outer diameter of the portion of the wire support main body 9 where the lip 13 is not provided. Incidentally, the outer diameter of the flange 11 of the wire support 3 is larger than an inner diameter of the waterproof cap 29.

In a waterproof cap installation state where the waterproof cap 29 is installed on the wire support 3, a rear end (annular edge of an opening) of the waterproof cap 29 abuts on the flange 11 of the wire support 3, and the wire support main body 9 and the portion (the conductor 17 and the like) of the wire 5 protruding forward from the wire support 3 are placed inside the waterproof cap 29. Incidentally, the waterproof cap 29 and the portion of the wire 5 protruding forward from the wire support 3 are in a non-contact state with each other.

In addition, the inner diameter of the portion of the waterproof cap 29 to be engaged with the wire support main body 9 and the outer diameter of the lip 13 of the wire support main body 9 are equal to each other in the waterproof cap installation state. This is achieved mainly by elastic deformation of the lip 13 of the wire support main body 9.

As a result, in the waterproof cap installation state, a gap between the waterproof cap 29 and the wire support main body 9 is sealed, and the splice 21 and the conductor 17 exposed to the one side of the wire support 3 including a part of the sheath 19 are sealed.

Even when the waterproof cap 29 is installed on the wire support 3 after the installation of the wires 5 and the dummy plugs 23 to the respective through-holes 7 of the wire support 3 is completed, the wire support 3 is slightly elastically deformed. As a result, the annular lip 15 on the inner wall of the through-hole 7 is brought into close contact with the entire outer circumference of the sheath 19 of the wire 5 and the entire outer circumference of the dummy plug main body 25 with a larger biasing force than the case where the waterproof cap 29 is not installed.

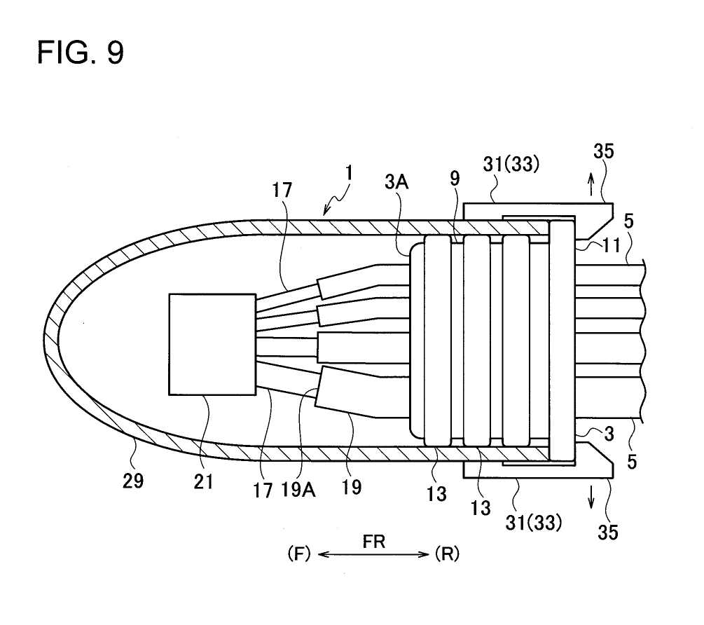

In addition, an installation state holding portion 31 configured to prevent the waterproof cap 29 installed on the wire support 3 from being disengaged from the wire support 3 may be provided as illustrated in FIG. 9.

The installation state holding portion 31 is configured to include a pair of elastic pieces 33 provided integrally with the waterproof cap 29, for example. In a state in the middle of installing the waterproof cap 29 on the wire support 3, the elastic piece 33 abuts on the wire support 3 and is elastically deformed by a force received from the wire support 3 (see an arrow in FIG. 9).

When the installation of the waterproof cap 29 on the wire support 3 is completed, the elastic piece 33 is restored as no force is received from the wire support 3. As a result of such restoration, a distal end 35 of the elastic piece 33 abuts on the flange 11 of the wire support 3 as illustrated in FIG. 9. Further, as a result of such abutment, the waterproof cap 29 installed on the wire support 3 is prevented from moving in the left direction in FIG. 9 to be disengaged from the wire support 3.

Incidentally, it may be configured such that the elastic piece 33 may be provided integrally with the wire support 3 instead of the waterproof cap 29.

Next, a wire bonding method, that is, a method of forming the wire bonding structure 1 will be described.

First, each of the plurality of wires 5 is installed into each of at least some plurality of through-holes 7 among the through-holes 7 provided in the wire support 3 such that each of these wires 5 penetrates through the through-hole so as to protrude toward one side of the wire support 3 by a predetermined length (a wire installation process A).

Subsequently, the sheath 19 is removed at a part (for example, one end) in the longitudinal direction of each of the wires 5 protruding by the predetermined length toward the one side of the wire support 3 (a wire sheath removal process B).

Incidentally, the installation of the wire 5 in the wire installation process A and the removal of the sheath 19 in the wire sheath removal process B are performed, for example, such that the sheath 19 of each of the wires 5 is removed after the installation of all the wires 5 on the wire support 3 is completed. That is, the wire sheath removal process B is executed after executing the wire installation process A.

Incidentally, if the first wire 5 becomes an obstacle at the time of removing the sheath 19 of the second wire 5, the sheath 19 of the second wire 5 is removed by setting a protruding amount of the second wire 5 from the wire support 3 to be larger than a protruding amount of the first wire 5.

After the sheath 19 is removed, the protruding amount of the second wire 5 is set to match the protruding amount of the first wire 5. For example, the protruding amount of the second wire 5 from the wire support 3 and the protruding amount of the first wire 5 from the wire support 3 are made equal to each other. Similarly, the sheaths 19 of the third and subsequent wires 5 are removed.

Subsequently, the dummy plugs 23 are installed in the remaining through-holes 7 of the wire support 3 to close all the remaining through-holes 7 after the wire 5 is installed in the wire installation process A and the sheath 19 is removed in the wire sheath removal process B (a dummy plug installation process C).

Subsequently, the respective conductors 17 positioned on the one side of the wire support 3 are bonded to each other after the wire 5 is installed in the wire installation process A and the sheath 19 is removed in the wire sheath removal process B (a bonding process D).

Subsequently, a part of the wire support 3 and the conductors 17 exposed to the one side of the wire support 3 are sealed by installing the sealing member 29 on the wire support 3 after the dummy plug 23 is installed in the dummy plug installation process C and the conductors 17 are bonded to each other in the bonding process (a sealing member installation process E).

Here, the bonding process D will be described in detail.

In the bonding process D, the conductors 17 of the respective wires 5, which have been installed on the wire support 3 in the wire installation process A, are sandwiched in a predetermined direction to bonding the respective conductors 17 to each other by ultrasonic bonding or the like.

When the sandwiching is performed in the bonding process D, the wire 5 has been installed on the wire support 3, and thus, the respective conductors 17 are aligned in the form of piled bales as viewed in the longitudinal direction of the wire 5 as illustrated in FIG. 6A. The sandwiching in the bonding process D causes one arbitrary conductor among the conductors 17 (any conductor among the conductors 17) to receive a biasing force in a direction intersecting a direction (for example, an up-down direction) of a force applied by the sandwiching, from another conductor in contact with the one arbitrary conductor among the conductors 17.

In other words, all of the conductors 17 are connected with the biasing forces by performing the sandwiching in the bonding process D. That is, the second conductor 17 is in contact with the first conductor 17 with the biasing force, and the third conductor 17 is in contact with the second conductor 17 with the biasing force. In this manner, all of the conductors 17 are continuously in contact with each other with the biasing forces.

That is, as the sandwiching is performed in the bonding process D, a conductor 17a illustrated in FIG. 6A is in contact with a conductor 17c while exerting biasing forces in an oblique direction to each other, the conductor 17c is in contact with a conductor 17b while exerting biasing forces in an oblique direction to each other, and all of the conductors 17 are continuously in contact with each other with the biasing forces.

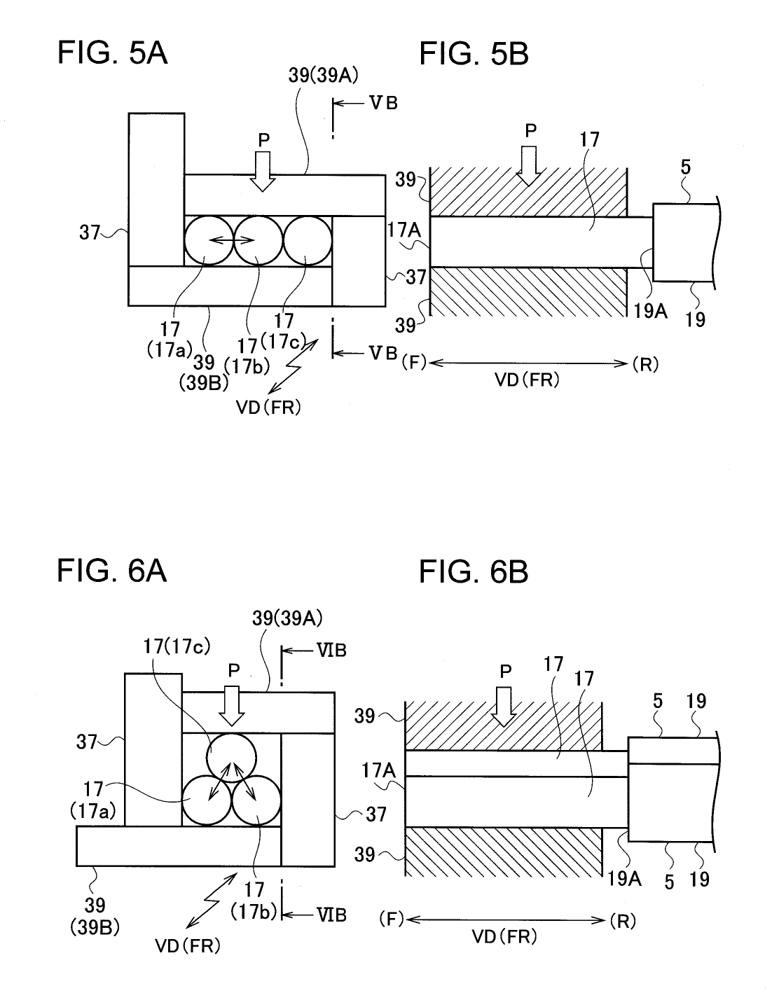

In an aspect in FIGS. 5A and 5B illustrating a comparative example, conductors 17 are just aligned side by side and are not arranged in the form of piled bales, and a conductor 17a and a conductor 17b are in contact with a small biasing force and a small bonding force therebetween, and the conductor 17b and a conductor 17c are in contact with each other with a small biasing force and a small bonding force therebetween even when the sandwiching is performed in the bonding process D.

This will be described more. During the sandwiching of the conductor 17 in the bonding process D, first, as illustrated in FIG. 6A, the plurality of conductors 17 are installed between a pair of members 37, which oppose each other with a predetermined distance therebetween in a lateral direction of FIG. 6A and into a space having a rectangular shape as viewed in the front-rear direction FR, the space between a pair of sandwiching member 39, which oppose each other with a predetermined distance therebetween in the up-down direction of FIG. 6A.

Incidentally, surfaces of the pair of members 37 opposing each other are flat surfaces parallel to each other. In addition, surfaces of the pair of sandwiching members 39 opposing each other are flat surfaces parallel to each other.

Subsequently, the sandwiching of the conductor 17 in the bonding process D is performed by moving at least one sandwiching member (for example, a sandwiching member 39A) between the pair of sandwiching members 39 (39A and 39B) in a direction (downward direction in FIG. 6A) with a predetermined pressure P in which the distance between the pair of sandwiching members 39 decreases. At this time, the distance between the pair of members 37 may be suitably decreased.

In the bonding process D, the conductors 17 exposed in a cantilever shape are elastically deformed by the sandwiching as illustrated in FIGS. 6B and 2B and are bent between the wire support 3 and the member 37 or the sandwiching member 39 so that the conductors 17 are arranged in the form of piled bales and in contact with each other with the biasing forces as illustrated in FIG. 6A.

In the bonding process D, for example, the conductors 17 are bonded to each other by ultrasonic bonding as described above. Therefore, the one sandwiching member 39A is an anvil and the other sandwiching member is a hone 39B. The hone 39B vibrates in a direction VD orthogonal to the paper surface of FIG. 6A (a left-right direction in FIG. 2B).

Although only the three conductors 17 having the same diameter are illustrated for convenience of description in FIG. 6A, a plurality of (three or more) conductors 17 having different diameters may be arranged.

According to the wire bonding structure 1, the wire support 3 has the plurality of through-holes 7 having different diameters, and the wires 5 are inserted into each of the through-holes 7 of the wire support 3 so that the wires 5 are held by the wire support 3. Thus, each arrangement (position) of the conductors 17 of the respective wires 5 is defined.

As a result, when bonding the conductors 17 of the wires 5 having different diameters to each other, it is possible to eliminate bonding failure between the conductors by accurately bonding the conductors 17 to each other.

In addition, since the respective conductors 17 are arranged in the form of piled bales when bonding the exposed conductors 17 to each other according to the wire bonding structure 1, it is possible to reliably bond the conductors 17 to each other.

In addition, since the dummy plug 23 closes the remaining through-hole 7 of the wire support 3 according to the wire bonding structure 1, it is possible to maintain a waterproof property. Further, it is possible to deal with the wire bonding structure 1 having a different specification by changing an installation form of the dummy plug 23 so that the versatility of the wire support 3 can be enhanced.

In addition, since the waterproof cap 29 covers a part of the wire support 3 and the conductor 17 exposed to one side of the wire support 3 according to the wire bonding structure 1, it is possible to seal the conductor 17 including the splice 21 (the conductor 17 exposed as the sheath 19 is removed).

In addition, since the installation state holding portion 31 is provided according to the wire bonding structure 1, it is possible to reliably prevent the waterproof cap 29 from being disengaged from the wire support 3 and to more reliably perform the sealing of the conductor 17 including the splice 21.

In addition, since the wire sheath removal process B is executed after the wire installation process A according to the wire bonding structure 1, it is possible to avoid the occurrence of bonding failure between the conductors 17 in the bonding process D even when foreign matters such as oil adheres to a surface of the wire support 3 (the inner surface of the through-hole 7).

More specifically, when the wire installation process A is executed after the wire sheath removal process B, there is a risk that foreign matters such as oil may adhere to the exposed conductor 17 when the wire 5 is caused to pass through the through-hole 7 of the wire support 3 so that the bonding failure between the conductors 17 may occur.

When the wire sheath removal process B is executed after the wire installation process A, however, foreign matters such as oil do not adhere to the conductor 17 exposed in the wire sheath removal process B after the wire installation process A even if the foreign matters such as oil adhere to the inner surface of the through-hole 7, and it is possible to avoid the occurrence of bonding failure between the conductors 17 in the bonding process D.

Incidentally, an execution order of the wire installation process A, the wire sheath removal process B, the dummy plug installation process C, the bonding process D, and the sealing member installation process E may be appropriately switched in the above-described wire bonding method.

The respective processes are executed (first mode) in the order of the wire installation process A, the wire sheath removal process B, the dummy plug installation process C, the bonding process D, and the sealing member installation process E in the above description. However, for example, the respective processes may be executed (a second mode) in the order of the wire installation process A, the wire sheath removal process B, the bonding process D, the dummy plug installation process C, and the sealing member installation process E, or the respective processes may be executed (a third mode) in the order of the wire installation process A, the dummy plug installation process C, the wire sheath removal process B, the bonding process D, and the sealing member installation process E.

In addition, the respective processes may be executed (a fourth mode) in the order of the wire sheath removal process B, the wire installation process A, the dummy plug installation process C, the bonding process D, and the sealing member installation process E, the respective processes may be executed (a fifth mode) in the order of the wire sheath removal process B, the wire installation process A, the bonding process D, the dummy plug installation process C, and the sealing member installation process E, or the respective processes may be executed (a sixth mode) in the order of the wire sheath removal process B, the dummy plug installation process C, the wire installation process A, the bonding process D, and the sealing member installation process E.

In addition, the respective processes may be executed (a seventh mode) in the order of the dummy plug installation process C, the wire installation process A, the wire sheath removal process B, the bonding process D, and the sealing member installation process E, or the respective processes may be executed (an eighth mode) in the order of the dummy plug installation process C, the wire sheath removal process B, the wire installation process A, the bonding process D, and the sealing member installation process E.

Meanwhile, the wire installation process A and the wire sheath removal process B may be performed alternately for each of the wires 5 (every single wire) in the first mode, the second mode, the fourth mode, the fifth mode, the seventh mode, and the eighth mode described above. For example, it may be configured such that the first wire 5 is installed in the first through-hole 7 of the wire support 3, the sheath 19 of this installed wire 5 is removed, and subsequently, the second wire 5 is installed in the second through-hole 7 of the wire support 3, and the sheath 19 of this installed wire 5 is removed.

If the first wire 5 becomes an obstacle at the time of removing the sheath 19 of the second wire 5, the sheath 19 of the second wire 5 is removed by setting the protruding amount of the second wire 5 from the wire support 3 to be larger than the protruding amount of the first wire 5. After the sheath 19 is removed, the protruding amount of the second wire 5 is set to match the protruding amount of the first wire 5. For example, the protruding amount of the second wire 5 from the wire support 3 and the protruding amount of the first wire 5 from the wire support 3 are made equal to each other. Similarly, the installation of the third and subsequent wires 5 on the wire support 3 and the removal of the sheaths 19 are performed. Further, the wire installation process A and the wire sheath removal process B may be performed alternately for each of the plurality of wires 5.

In addition, the wire installation process A, the wire sheath removal process B, the dummy plug installation process C may be performed alternately in the first mode, the third mode, the fourth mode, the seventh mode, and the eighth mode described above. Further, the dummy plug installation process C may be executed last in all the above-described modes.

In addition, the flange 27 of the dummy plug 23 is in contact with a rear end face of the wire support 3 as the dummy plug 23 is inserted into the through-hole 7 of the wire support 3 from the rear side R of the wire support 3 to be installed in the above description. However, the flange 27 of the dummy plug 23 may be in contact with a front end face of the wire support 3 by inserting the dummy plug 23 into the through-hole 7 of the wire support 3 from the front side F of the wire support 3 to be installed.

In this case, the installation of the dummy plug 23 on the wire support 3 is performed before bonding the conductors 17 to each other.

As a result, the dummy plug 23 is prevented from slipping out of the through-hole 7 of the wire support 3. That is, even if the dummy plug 23 moves forward from the through-hole 7 of the wire support 3 by a predetermined distance, the dummy plug 23 abuts on the splice 21 of the conductor 17 and does not slip out further.

Incidentally, it is assumed that the sealing property between the dummy plug 23 and the through-hole 7 is secured even in the state where the dummy plug 23 moves forward by the predetermined distance from the through-hole 7 of the wire support 3.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A wire bonding structure comprising:
a wire support which is made of a water-impermeable material and is provided with a plurality of through-holes such that an inner diameter of some through-holes among the plurality of through-holes is different from an inner diameter of the other through-holes among the plurality of through-holes; and
a plurality of wires each of which is configured to include a conductor and a sheath covering the conductor and in which the sheath is removed at a part in a longitudinal direction to expose the conductor, the conductors penetrate through at least some through-holes among the plurality of through-holes of the wire support such that the exposed conductors are positioned on one side of the wire support, and the conductors penetrated through the through-holes are bonded to each other.

2. The wire bonding structure according to claim 1 further comprising a dummy plug that closes a remaining through-hole of the plurality of through-holes of the wire support.

3. The wire bonding structure according to claim 1 further comprising a sealing member that covers a part of the wire support and the conductors exposed to the one side of the wire support.

4. The wire bonding structure according to claim 3, wherein
the sealing member is configured to be installed on the wire support, and
an installation state holding portion configured to prevent the sealing member installed on the wire support from being disengaged from the wire support is provided.

5. A wire bonding method for bonding a plurality of wires penetrating through a wire support, each wire including a conductor and a sheath covering the conductor, and the wire support made of a water-impermeable material and is provided with a plurality of through-holes such that an inner diameter of some through-holes among the plurality of through-holes is different from an inner diameter of the other through-holes among the plurality of through-holes, the method comprising:
installing each wire of the plurality of wires into each through-hole, which is at least some of through-holes among the plurality of through-holes, so as the plurality of wires to penetrate through the at least some of through-holes to protrude toward one side of the wire support by a predetermined length;
removing the sheath at a part in a longitudinal direction of each of the wires protruding toward the one side of the wire support by the predetermined length;
installing a dummy plug to a remaining through-hole of the plurality of through-holes of the wire support to close the remaining through-hole;
bonding the conductors positioned on the one side of the wire support to each other; and
sealing a part of the wire support and the conductors exposed to the one side of the wire support by installing a sealing member on the wire support after bonding the conductors to each other.
